(19) United States
(12) Patent Application Publication
(10) Pub. No.: US 2011/0202425 A1
(43) Pub. Date: Aug. 18, 2011

(54) SELF CHECKOUT SYSTEM

(76) Inventors: Richard Hui, Coquitlam (CA); John Almond, West Vancouver (CA)

(21) Appl. No.: 13/014,039

(22) Filed: Jan. 26, 2011

Related U.S. Application Data
(60) Provisional application No. 61/303,784, filed on Feb. 12, 2010.

(51) Int. Cl. G06Q 30/00

(52) U.S. Cl. 705/26.8

(57) ABSTRACT

A self check out system comprises a hardware device for inputting purchase information and a means for payment and confirmation of the payment prior to exiting the store. A network permits communication between the hardware device and a server and deactivation of an existing security system which may include a tag device on the purchased good. The server stores the purchase information and the copy of the related receipt.

### BACKGROUND OF THE INVENTION

1. Field of the Invention

The present invention relates to a self check out system. Particularly the present invention relates to a check out system which allows for a shopper to pay for goods at a store, without the need for a traditional cashier using automated wireless technology.

2. Description of the Related Art

In store purchases are a part of our everyday lives. In common systems today, shoppers typically select the goods they wish to purchase and then pay at a cashier station. Some retailers have implemented a type of self check out where shoppers utilize a self check out station that involves scanning of bar codes and payment using a credit card at a fixed terminal station on the store floor. The self check out system in this case is usually supervised by a store staff member. Although this can allow shoppers to self serve, this system is still subject to pressure from volume users. In today's environment, it currently offers a “faster” method of check out due to the low adaptation rates. As user adaptation rates increase, longer line ups will yield the same end result. The check out process is an area where retailers want to speed up in order to improve customer satisfaction and avoid loss of sales.

Due to large volumes of shoppers and long line ups, many people avoid shopping busy locations or busy retailers or certain times of the day. Time is a precious commodity and people generally consider standing in long line ups a waste of time.

Other then the traditional cashier system and the cumbersome self check out, there is not other method currently in place to make this process more efficient.

There is accordingly a need for an improved self purchase system.

### SUMMARY OF THE INVENTION

It is an object of the present invention to provide a self check out system.

It is a further object of the present invention to provide a self check out system which allows for the selection and identification of goods in store, a secure and verified payment method and in store confirmation system.

There is accordingly provided a self check out system comprising a hardware device, such as a smart phone or other mobile terminal for inputting product information into a device in preparation for check out. Products can be identified by bar code, RFID, manual code or other automated scanning method and added to the purchase list. This information is then loaded into the software contained in the hardware system. Methods of quantity and the deletion of items from the purchase list will allow users to further control the purchase list and provide a running total. Appropriate coupons or discounts can also be applied to the system from the in store system, bar code or other manual code input.

Once the shopper has completed their shopping, they may proceed to cheek out with the mobile device. The system will provide the ability for the user to have pre-loaded payment information for faster check out. Pre-loaded information can include store customer ID, membership or other unique identifier, name, address, phone, and payment method. If information has been pre-loaded, the user can check out with the simple entry of a Personal Identification Number or other unique method such as finger print, facial recognition or eye scan. In the case of credit card or debit use, the funds will be taken immediately. Payment can be immediately transferred to the retailer or batched for end of day or other set time periods.

Once the payment has been made, the system generates the user a receipt as well as a unique identification number. This information is then transferred to the retailer confirmation system. This system will typically be located near or at the exit of the retail store for verification of the purchase and the actual good purchased. The system also accounts for an automated security screening device remover which would apply to stores using security tags or other similar devices. Security devices are methods used by retailers to deter shoplifting or other criminal related acts. Security devices are typically embedded in the product and must be de-activated or removed prior to leaving the store. This invention can also include a device and method that can de-active the security system either wirelessly or in with an in store mechanism. The retail staff member will be able to view a complete list of items purchased from the user and verified payment information through the unique identifier. Once the staff member has verified payment and goods, the staff member may close the transaction and the user can be on their way. In the case where RFID (Radio Frequency Identification tags), the check out system may not require a staff member to verify purchases. Purchases may be verified automatically by the RFID system.

The self check out system disclosed herein provides the advantage of allowing shoppers to more efficiently purchase goods from retail locations and avoid line ups. In addition, it provides retailers with a method to reduce line ups and improve customer satisfaction and purchase

### BRIEF DESCRIPTION OF DRAWINGS

The invention will be more readily understood from the following description of preferred embodiments thereof given, by way of example only, with reference to the accompanying drawings, in which:

FIG. 1 is a block diagram of an improved self check out system

### DESCRIPTION OF THE PREFERRED EMBODIMENTS

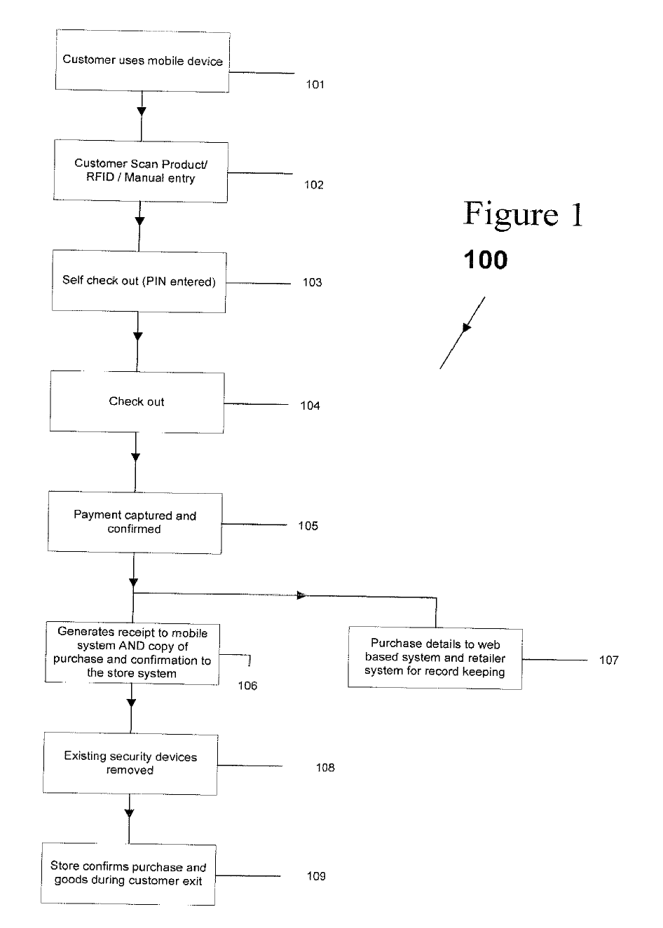

Referring to the drawings and first to FIG. 1 this is a block diagram of a self check out system 100. System users may be consumers, businesses or any other interested party. Each user is identified by the system 100 using a unique identifier such as a username and password, PIN and be in possession of a mobile device. In the example shown in FIG. 1, a user accesses the system 100 by activating a unique mobile hardware device such as smart phone, scanner, or other suitable device outfitted with appropriate software. As shown at block 102 a product bar code or UPC code is scanned into the system to confirm product SKU and price. This provides the system 100 with information to identify the product, make and model, quantity, price, product code, purchase location, method of payment, phone number, address as well as other purchase details. This information is collectively known as the product information. As shown at block 103, the system 100 prompts the user to enter a PIN or other unique identifier after purchase details are confirmed and the user has decided to check out. Block 104 describes the check out process, where the unique identifier via secure means conducts an actual transaction resulting in captured payment at Block 105. After the transaction is made, a receipt confirmation is generated to the user as well as the retails store with a unique identifier. Block 107 describes how the data is communicated to the retailers system for record keeping and purchase confirmation. This information is also loaded into a web based system for the user and retailer for record keeping. After the user completes Block 106, any existing security device is removed and a store member or automated system verifies the user has the actual goods purchased and closes the transaction in Block 109.

What is claimed is:

1. A self check out system comprising:
a hardware device for inputting product information and payment details;
a server for storing the product and purchase information
a network for permitting communication between the hardware device and the server; and
a means to de-activate a security system either wirelessly or in store
a security device that can de-activated remotely via a web based system
a means for verifying the authenticity of the purchase and the related goods.
